(19) United States
(12) Patent Application Publication
(10) Pub. No.: US 2002/0106260 A1
(43) Pub. Date: Aug. 8, 2002

(54) Screw connection with countersunk screw

(76) Inventor: Manfred Schenk, Friedrichshafen (DE)

Correspondence Address: DAVIS & BUJOLD, P.L.L.C., 500 NORTH COMMERCIAL STREET, FOURTH FLOOR, MANCHESTER, NH, 03101, US

(21) Appl. No.: 10/052,021

(22) Filed: Jan. 18, 2002

(30) Foreign Application Priority Data
Jan. 26, 2001 (DE) 101 03 418.0

(51) Int. Cl. F16B 23/00

(52) U.S. Cl. 411/399

(57) ABSTRACT

In screw connections with countersunk screws, certain tolerances are common for the supporting faces of the screw head and also of the counterbore. To make obtaining a precisely defined prestress of the screw connection possible, the formerly known methods are not sufficient since, due to the usual tolerances, too large a variation of the prestress occurs. This invention proposes a contact surface (15), almost linear in a peripheral direction, such as between the countersunk screw (1) and the counterbore (7). Thereby the divergence of the operative radius of the screw head friction and the screw head deformation, in the tolerances usual for mass production, are kept within the narrowest possible limits. It is thus possible to guarantee a precisely defined prestress of the screw connection with known tightening methods.

The invention relates to a screw connection of the kind defined in detail in the preamble, especially for several high-load parts with a precisely defined prestress for interconnecting them.

Countersunk screws with hexagonal recess have been described in DIN EN ISO 10642. The tolerance of the angle of taper of the screw head is fixed here at 90°+0°/−30′. In DIN 74-1, the tolerance of the angle of the counterbores for countersunk screws having hexagonal recess is given at 90°±1°. Therefore, because of the possible production tolerances during the screw connection, the screw head, in tolerance limiting positions, can abut against the counterbore via its internal or its external tapered area.

In a screw joint thus exists in the tolerance limiting positions different operative radii of the frictional forces on the tapered area of the screw head. Under a constant tightening torque this allows the prestresses obtained in both tolerance limiting positions to differ sharply from each other. Therefore, a torque-controlled tightening of the counterscrew cannot guarantee that a precisely defined prestress is obtained for the countersunk screw.

In the tightening of the countersunk screw there are also needed in the tolerance limiting positions different sizes of rotation angles of the screw in order to achieve a specific prestress. This is due to the fact that the screw head deforms when abutting against the outer head cone while the tightening torque increases. This means that when abutting against the external head cone, the necessary angle of rotation is larger than when abutting against the internal. Therefore, it also cannot be guaranteed that a precisely defined prestress of the countersunk screw is achieved with the usual tolerances of the screw connection via a tightening controlled by an angle of rotation.

It is known that a characteristic curve of the tightening torque appears when the countersunk screw abuts against the outer part of its head cone in the hollow of the bore and the screw head deforms when the load increases. There appears here, in the tightening curve, first an ascending, then a descending and finally again an ascending torque curve. With the current tightening tools, such torque curve cannot be monitored precisely enough to ensure a defined prestress for the screw connection.

During tightening of the countersunk screw controlled by yield-resistance, problems arise when parts having different expansion coefficients are bolted. Especially under stress of great temperature change for a composite, it can occur that the parts to be bolted expand so much more than the screw so that the screw is loaded beyond its yield resistance. This method is thus not suited to tighten a precisely defined prestress with usual countersunk screws heavy loaded connections of parts having different thermal expansion.

The problem on which this invention is based is to develop a screw connection with countersunk screws by which the heavy loaded parts, especially parts of different thermal expansion, can be connected with a precisely defined prestress of the screw.

This problem is solved with a screw connection which, together with the features of the preamble, includes the features of the characteristic part of the main claim.

The invention is represented in the following figures which show:

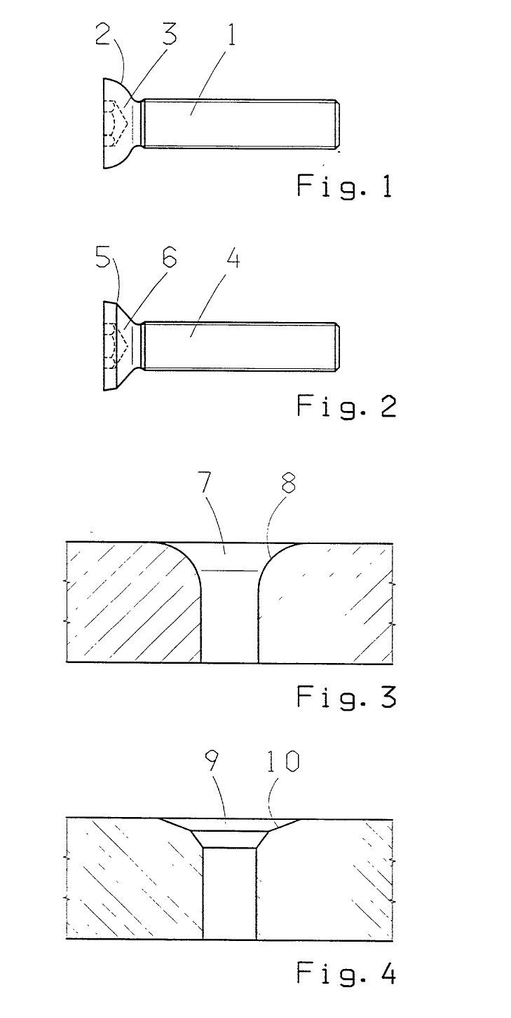

FIG. 1 is a countersunk screw with a defined crown of the head supporting face;

FIG. 2 is a countersunk screw with a two-step cone as a head supporting face;

FIG. 3 is a counterbore with a defined crown of the supporting face;

FIG. 4 is a counterbore with a two-step cone as a head support;

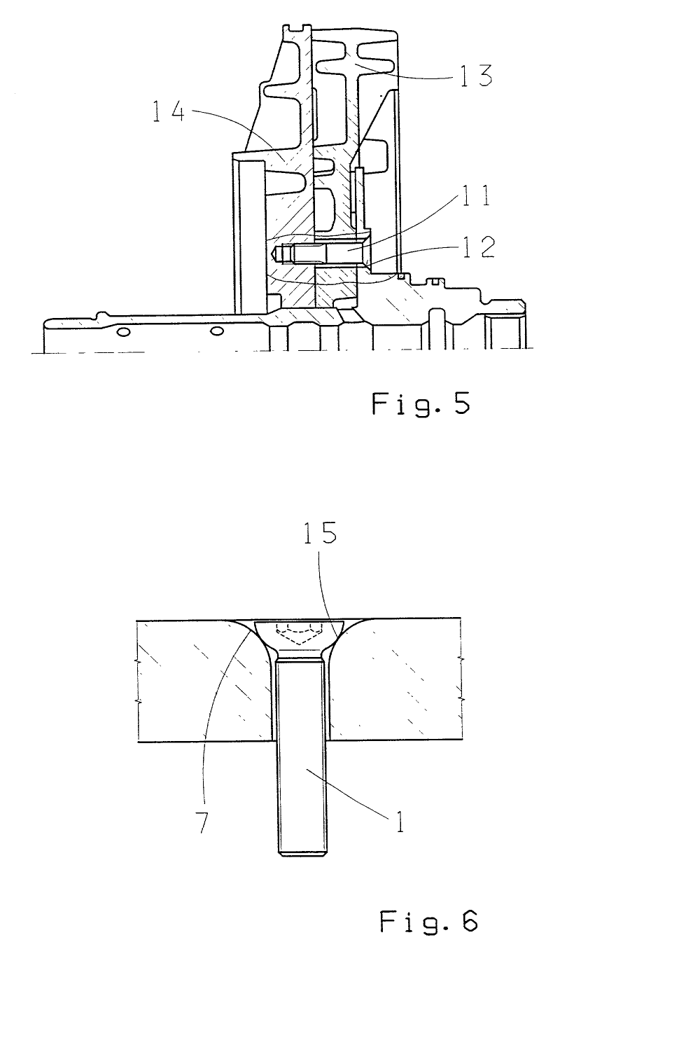

FIG. 5 is a stator shaft bolting for an automatic transmission; and

FIG. 6 is an installation drawing of a countersunk screw according to FIG. 1 and the counterbore according to FIG. 3.

In FIG. 1, a countersunk screw 1 is shown which can be threaded into a standard counterbore. Thereby the already existing counterbore can be further used which favors production costs. The head supporting face 2 of the screw head 3, in an axial direction, has a defined roundness. Said roundness is preferably centrally laid out but can also be otherwise aligned. Thereby a linear contact is obtained, in a peripheral direction, with a relatively small change of the operative radius of the frictional forces over the whole band width of the tolerances common for mass production. Besides, by virtue of the relatively constant head support, the deformation of the screw head remains stable, to a great extent, for all tolerance positions and a correspondingly uniform elasticity of the screw connection is achieved. It is thus possible to define the needed tightening torque or the needed angle of rotation so that, within the tolerance limiting positions usual for mass production, a precisely defined prestress of the screw connection can also be guaranteed.

It is likewise possible to “reverse” the above mentioned pairing and to screw a standardized countersunk screw in a counterbore 7, as shown in FIG. 3. The supporting face 8 of the counterbore 7 has, in an axial direction, a defined roundness. Thereby a linear contact is achieved in a peripheral direction with a relatively small change of the operative radius of the frictional forces over the whole band width of the tolerances common in mass production. Besides, due to the relatively constant head support, the deformation of the screw head remains stable, to a large extent, for all tolerance positions and a correspondingly uniform elasticity of the screw connection is obtained. Like already in the above mentioned pairing, it is possible to define the necessary tightening torque or the necessary angle of rotation in a manner such that a precisely defined prestress, also within the tolerance limiting positions usual for mass production, can be ensured for the screw connection.

One other preferred structure of a countersunk screw 4, which can also be threaded into a standardized counterbore, is shown in FIG. 2. The head supporting face 5 of the screw head 6 is described as a two-step cone. Thereby a linear contact is achieved, in a peripheral direction, with a relatively small change of the operative radius of the frictional forces over the whole band width of the tolerances common in mass production. In addition, due to the relatively constant head support, the deformation of the screw head remains extensively stable for all tolerance positions and an accordingly uniform elasticity of the screw connection is obtained. It is thus possible to define the necessary tightening torque or the necessary angle of rotation so that a precisely defined prestress, also within the tolerance limiting positions common for mass production, can be guaranteed in the screw connection.

The pairing described can also be here, so to speak, reversed by threading a standardized countersunk screw into a counterbore 9, according to FIG. 4. The supporting face 10 of the counterbore 9 is also described as a two-step cone. Thereby a linear contact is obtained, in a peripheral direction, with a relatively slight change of the operative radius of the frictional forces over the whole band width of the tolerances usual in mass production. In addition, due to the relatively constant head support, the deformation of the screw head remains stable, to a large extent, for all tolerance positions and an accordingly uniform elasticity of the screw connection is accomplished. It is, therefore, possible to define the necessary tightening torque or the necessary angle of rotation so that a specific prestress, also within the tolerance limiting positions common for mass production, can be guaranteed for the screw connection.

It is naturally possible to create and apply ingenious combinations from the above described designs.

A preferred example of utilization is shown in FIG. 5. The stator shaft 13 must be connected via a countersunk screw 11 with the intermediate plate 14. The countersunk screw 11 and the counterbore 12 thereof must consist of a combination of the already described embodiments.

The expert knows this critical screw connection in automatic transmissions where the stator shaft 13 must be connected with the transmission housing or the stator shaft 13, via an intermediate plate 14, with the transmission housing. In this screw connection, especially high loads appear for the following reasons:

Since the construction must be increasingly compact, the axial installation space is extremely limited. At the same time, due to the existing oil supply ducts in the stator shaft 13, the possible number of bores for bolting is limited. Notwithstanding this, a high supporting torque of the converter, the same as vibrations due to oscillations of the drive chain, have to be absorbed. To this is added that transmissions are usually designed to operate at temperatures from −40° C. to +150° C. Since for reasons of manufacture, the stator shaft 13 must be made of steel and the housing, the same as the intermediate plate 14, of aluminum, the different expansion coefficients have to be taken into account.

Finally, FIG. 6 shows the combination of the countersunk screw 1 with the counterbore 7 having a contact surface 15 therebetween.

Reference Numerals

1 countersunk screw

2 head supporting face of the countersunk screw

3 screw head

4 countersunk screw

5 head supporting face of the countersunk screw

6 screw head

7 counterbore

8 supporting face of the counterbore

9 counterbore

10 supporting face of the counterbore

11 countersunk screw

12 counterbore

13 stator shaft

14 intermediate plate

15 contact surface between countersunk screw and counterbore

1. Screw connection to connect at least 2 parts with a countersunk screw (1, 2), characterized in that the contact surface between the screw head (3, 6) of said countersunk screw (1, 2) and the counterbore (7, 9) is almost linear in peripheral direction.

2. Screw connection according to claim 1, characterized in that the supporting face (2) of said countersunk screw (1) has a defined crowning in axial direction and said counterbore is designed as one-step cone.

3. Screw connection according to claim 1, characterized in that said supporting face (5) of said countersunk screw (4) consists of a two-step cone and said counterbore is designed as one-step cone.

4. Screw connection according to claim 1, characterized in that said supporting face (8) of said counterbore (7) has a defined crowning in axial direction and said supporting face of said counterscrew is designed as one-step cone.

5. Screw connection according to claim 1, characterized in that the supporting face (10) of said counterbore (9) consists of one two-step cone and said countersunk screw is designed as one-step cone.

6. Screw connection according to claim 1, characterized in that said supporting face (2) of said countersunk screw (1) has a defined crowning in axial direction and said supporting face (10) of said counterbore (9) consists of one two-step cone.

8. Screw connection according to claim 1, characterized in that said supporting face (5) of said countersunk screw (4) consists of one two-step cone and said supporting face (8) of said counterbore (7) has a defined crowning in axial direction.

9. Screw connection according to claim 1, characterized in that said countersunk screw (4) and said supporting face (10) of said counterbore (9) consist of one two-step cone.

10. Screw connection according to any one of claims 1 to 9, characterized in that one stator shaft (13) is connected with an intermediate plate (14).
